(19) United States
(12) Patent Application Publication
(10) Pub. No.: US 2020/0341167 A1
(43) Pub. Date: Oct. 29, 2020

(54) Complexity Index Optimizing Job Design

(71) Applicant: Halliburton Energy Services, Inc., Houston, TX (US)

(72) Inventors: Dinesh Ananda Shetty, Sugarland, TX (US); Robert Douglas Hillard, Houston, TX (US); Harold Grayson Walters, Tomball, TX (US); Neil Alan Stegent, Cypress, TX (US)

(73) Assignee: Halliburton Energy Services, Inc., Houston, TX (US)

(21) Appl. No.: 16/397,833

(22) Filed: Apr. 29, 2019

(51) Int. Cl. G01V 99/00; G06F 17/50

(52) U.S. Cl. CPC G01V 99/005; G06F 17/5009

(57) ABSTRACT

Selecting a fracing-plan-to-apply to optimize a complexity index includes identifying a set of controllable input variables that defines a fracing plan. Initial values for the set of controllable input variables are defined. The initial values of the set of controllable input variables are processed to produce an initial stimulated geometry. A complexity estimator is applied to the initial stimulated geometry to produce an initial complexity index, which is evaluated to identify at least one variation from the initial values, which is processed to produce a variation stimulated geometry for each of the at least one variation from the initial values. The complexity estimator is applied to the at least one variation stimulated geometry to produce a variation complexity index for each of the at least one variation from the initial values. The fracing-plan-to-apply is selected from among the initial values and the at least one variation from the initial values.

### BACKGROUND

Hydraulic fracturing (or “fracing”) is commonly used to improve production from wells. Fracing is typically expensive and reducing the cost of fracing while achieving production goals is desirable. Often, computer models of underground fractures (called “fracture networks”) are used to test the effectiveness of fracture plans.

Complex fracture networks may be inadequately described by simplistic fracture descriptions. Fracture network features such as cluster spacing, well spacing, treatment size, previously completed wells nearby, and natural fracture networks may be helpful in improving fracture descriptions. Optimizing a fracture network design to achieve goals is a challenge.

### BRIEF DESCRIPTION OF THE DRAWINGS

FIG. 1 is a representation of a naturally fractured reservoir with a borehole.

FIG. 2 is a representation of the naturally fractured reservoir and borehole of FIG. 1 with a representation of a stimulated geometry produced by a fracing plan.

FIG. 3 is a representation of the naturally fractured reservoir and borehole of FIG. 1 with the representation of the stimulated geometry produced by the fracing plan of FIG. 2 with a bounding shape corresponding to a stimulated reservoir domain.

FIG. 4 is a representation of the naturally fractured reservoir and borehole of FIG. 1 with representation of the stimulated geometry produced by the fracing plan of FIG. 2 with a bounding shape corresponding to a propped reservoir domain.

FIG. 5 is a flow chart of a work flow.

FIG. 6A is a representation of a bounding shape for a small pumping volume.

FIG. 6B is a representation of a bounding shape for a medium pumping volume.

FIG. 6C is a representation of a bounding shape for a large pumping volume.

FIG. 7A is a representation of a bounding shape for a smaller number of clusters per stage.

FIG. 7B is a representation of a bounding shape for a larger number of clusters per stage.

FIG. 8 is a flow chart depicting a process for selecting a fracing-plan-to-apply to optimize a complexity index.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

A workflow is described herein to determine a volume of fluid and proppant pumped and a perforation design to maximize the density of the generated fractures. A metric is defined to describe the effectiveness of hydraulic fracturing to induce complex network geometry.

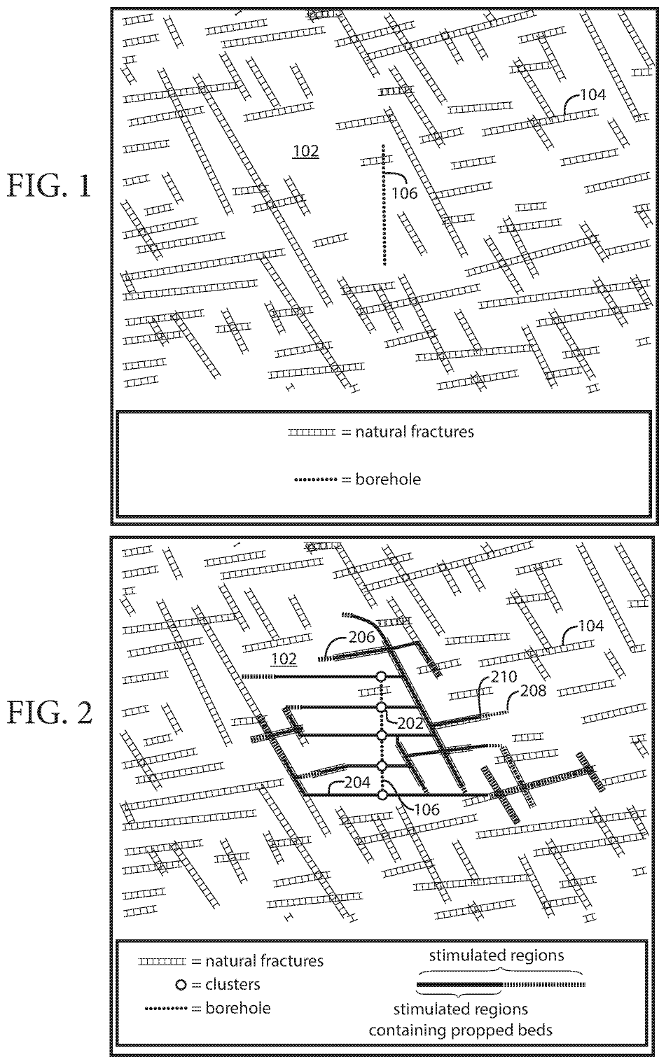

FIG. 1 is a representation of a naturally fractured reservoir with a borehole. The reservoir 102 includes natural fractures 104 (only one of the natural fractures is labeled; the key on FIG. 1 identifies the symbols used on the figure). A borehole 106 has been drilled into the reservoir 102. It will be understood that FIG. 1 is a two-dimensional (“2D”) representation of a three-dimensional (“3D”) space as is indicated by the overlapping natural fractures 104.

It is desired to execute a fracing process to exploit the existing natural fractures and to create new fractures in the reservoir 102 to improve production from the reservoir 102. To do this, the borehole 106 is perforated to allow injection of fracing fluids and proppants into the reservoir 102. The perforations may be grouped into clusters. Clusters may be, in turn, grouped into stages.

A “fracing plan” is defined by a set of controllable input variables. The set of controllable input variables may include the number and location of stages, the number and location of clusters within the stages, the number and location of perforations within the clusters, the volume of hydraulic fluid pumped, and the volume of proppant pumped. The controllable input variables are processed to produce a stimulated geometry that shows the extent of stimulation within the reservoir 102 resulting from the fracing plan.

FIG. 2 is a representation of the naturally fractured reservoir and borehole of FIG. 1 with a representation of a stimulated geometry produced by a fracing plan. As can be seen, several clusters 202 (only one is labeled) have been identified along the borehole 106. In addition, the volumes of fracing fluid and proppant have been specified resulting in stimulated regions 204 (only one is labeled) and the parts of the stimulated region containing the propped bed (where the bed height is assumed to be relevant only if it is above some threshold value, for example 10% of the fracture height) 206 (only one is labeled), which are indicated by the symbology defined in the key to FIG. 2, and which represent the stimulated geometry produced by the fracing plan. It will be understood that varying one or more of the controllable input variables will likely result in a different stimulated geometry.

The problem becomes evaluating the different stimulated geometries to select the optimum fracing plan. In general, hydraulic fracturing efficiency is assessed as the half length of generated fracture. However, such metric typically is applicable only to symmetric planar fractures, and the possibility of obtaining symmetric planar fractures for realistic problems is almost nonexistent. The technique described herein uses a different type of metric to assess the impact of hydraulic fracturing.

The technique described herein uses a geometry-based indicator of the effectiveness of hydraulic fracturing. For example, the technique may seek to optimize, or, in some situations to maximize, a “complexity index.” An example of a complexity index may be a comparison of the total length of fracture to the size of a bounding shape.

A bounding shape is a shape defined by points on a stimulated geometry whose location is determined or influenced by the values of the controllable input variables. For example, in FIG. 2, such points may include the end points of the stimulated regions 208 (only one is labeled) or the end points of the stimulated regions containing propped beds 210 (only one is labeled).

A bounding shape is created by linking points on the stimulated geometry using any of the known algorithms for generating bounding geometry. For example, ellipse techniques, convex hull techniques, or alpha shape techniques may be employed to create the bounding shape. A convex hull is the smallest convex set that contains a set of points X. An alpha shape is similar to a convex hull but is not restricted to the smallest convex set. An ellipse technique draws an ellipse, or another geometrical shape, around the set of points. Other techniques may be used and it will be understood that these techniques may be used in two dimensions, three dimensions, or a larger number of dimensions.

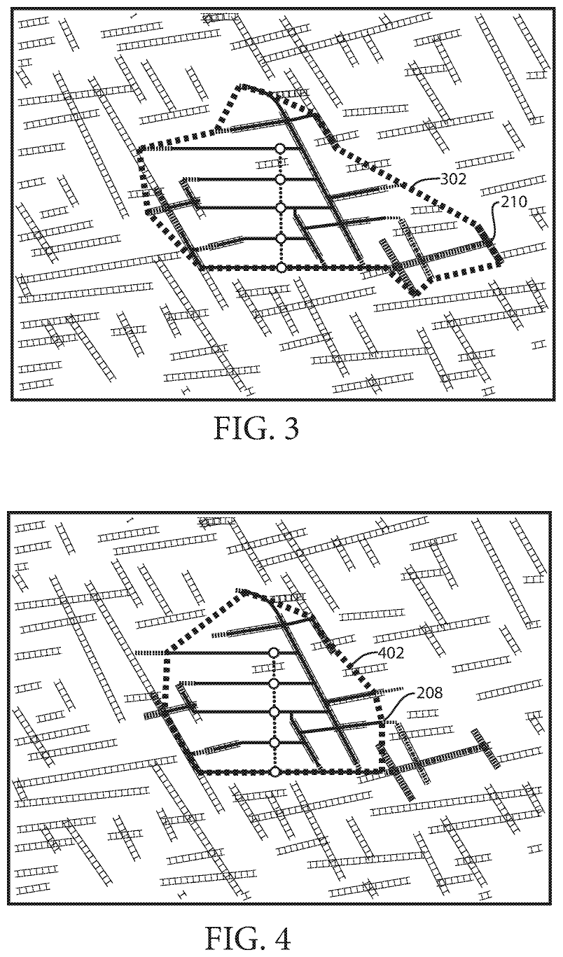

FIG. 3 is a representation of the naturally fractured reservoir and borehole of FIG. 1 with the representation of the stimulated geometry produced by the fracing plan of FIG. 2 with a bounding shape corresponding to a stimulated reservoir domain. The stimulated bounding shape 302 illustrated in FIG. 3 is an alpha shape through the end points of the stimulated regions containing propped beds 210 (only one is labeled).

FIG. 4 is a representation of the naturally fractured reservoir and borehole of FIG. 1 with representation of the stimulated geometry produced by the fracing plan of FIG. 2 with a bounding shape corresponding to a propped reservoir domain. The propped bounding shape 402 illustrated in FIG. 4 is an alpha shape through the end points of the stimulated regions 208 (only one is labeled).

It will be understood that other bounding shapes can be identified and that such bounding shapes need not be tied to the end points of the stimulated regions 208 or the end points of the stimulated regions containing propped beds 210. For example, the bounding shape may be a predetermined shape. One example of such a predetermined shape is a circle centered against the center of clusters or an ellipse that contains all the clusters.

Once the bounding shape is identified or determined, a geometry-based indicator of fracing effectiveness can be established. For example, a “complexity index” can be defined as:

Complexity Index^{d}=d(Fracture)/d(Bounding Shape)

where d is the dimensionality of the fracture.

For example,

$$when d = 1$$

$$Complexity {Index}^{1} = \frac{Total length of fracture}{Circumference of bounding shape}$$

$$when d = 2$$

$$Complexity {Index}^{2} = \frac{Total area of fracture}{Area of bounding shape}$$

$$and when d = 3$$

$$Complexity {Index}^{3} = \frac{Total Volume of fracture}{Volume of bounding shape}$$

and so on (i.e., d may be greater than 3). When a predetermined bounding shape is used, the area of the shapes may be tabulated against the complexity indices produced by different input parameters. The resulting curve may be used to make design decisions.

Another possible geometry-based indicator of fracing effectiveness may be “Circularity,” defined as:

$$Circularity = \frac{4 π A}{{p}^{2}}$$

where A is the area of the bounding shape and P is the perimeter of the bounding shape, respectively. While Circularity is a two-dimensional concept, it will be understood that similar concepts may be used in higher order systems, such as “sphericity” in a three dimensional system.

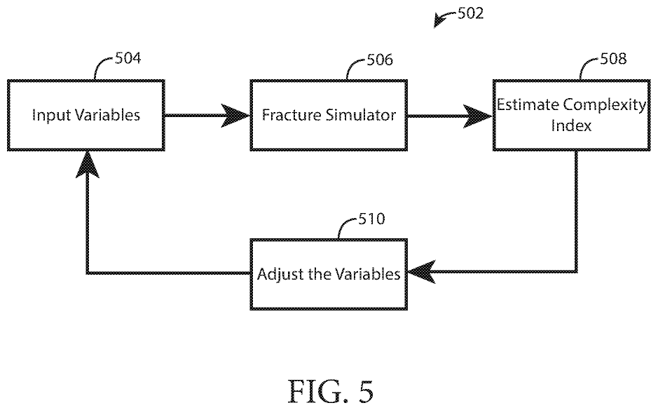

FIG. 5 is a flow chart of a work flow. The work flow 502 begins by defining an initial set of controllable input variables 504, such as the number and location of stages, the number and location of clusters within the stages, the number and location of perforations within the clusters, the volume of hydraulic fluid pumped, and the volume of proppant pumped. The initial set of controllable input variables may come from previous design knowledge. A fracture simulator 506 may be run with the initial set of controllable input variables 504 to produce a stimulated geometry of the form shown in FIG. 2. Alternatively, the stimulated geometry may be derived by alternative techniques, such as be applying fracture mapping algorithms to microseismic measurements or to measurements from surface tiltmeters, as described in M. K. Fisher, C. A. Wright, B. M. Davidson, A. K. Gordon, E. O. Fielder, W. S. Buckler, and N. P. Steinsberger, “Integrated Fracture Mapping Technologies to Optimize Stimulations in the Barnett Shale,” Proceedings of the Society of Petroleum Engineers (SPE 77441) (Society of Petroleum Engineers 2002). A complexity estimator 508 determines the Complexity Index^{d} for the stimulated geometry. The set of controllable input variables are then adjusted 510 and the loop is repeated. The adjustments may be made in a design of experiment manner, where a user investigates the input variable space for optimal values of these indices, or as an optimization run to maximize the complexity index via methods such as Newton Raphson method, Gradient descent method, etc.

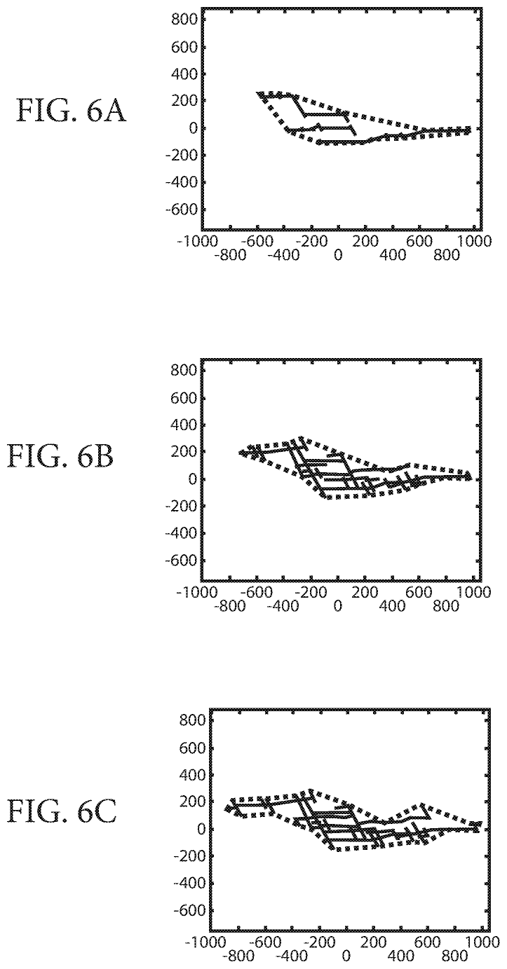

FIG. 6A is a representation of a bounding shape for a small pumping volume. FIG. 6B is a representation of a bounding shape for a medium pumping volume. FIG. 6C is a representation of a bounding shape for a large pumping volume. FIGS. 6A, 6B, and 6C illustrate results of applying the workflow 502. The Complexity Index¹ value for these scenarios is 1.2 (FIG. 6A), 2.0 (FIG. 6B), and 1.9 (FIG. 6C). The peak value of Complexity Index¹ is attained for the medium pumping volume (FIG. 6B), leading to the counterintuitive result that pumping more does not improve the metric.

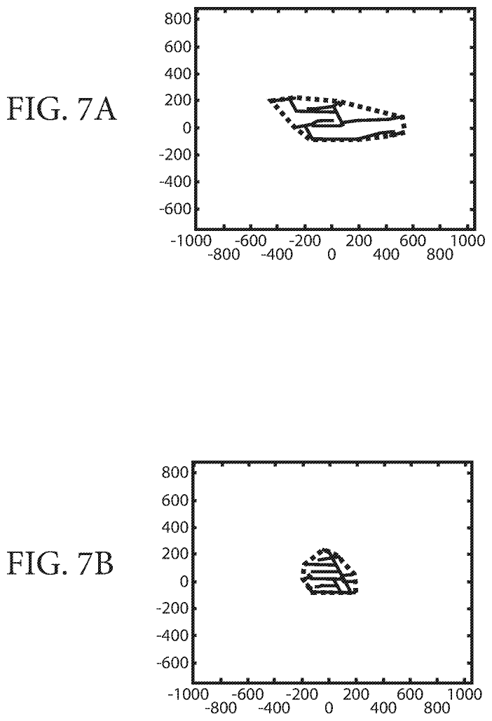

FIG. 7A is a representation of a bounding shape for a smaller number of clusters per stage. FIG. 7B is a representation of a bounding shape for a larger number of clusters per stage. In FIGS. 7A and 7B, the number of clusters per stage is different while all other parameters remain the same. The bounding shape is conformed to the propped region, as in FIG. 4. FIG. 7A is for 3 clusters per stage and FIG. 7B is for with 5 clusters per stage. The Complexity Index¹ for the FIG. 7A scenario is determined to be 1.9 and the Complexity Index¹ for the FIG. 7B scenario is determined to be 2.9. Also, the circularity indexes are determined to be 0.5 and 0.86, respectively. Thus, both metrics here have higher values for 5 clusters per stage.

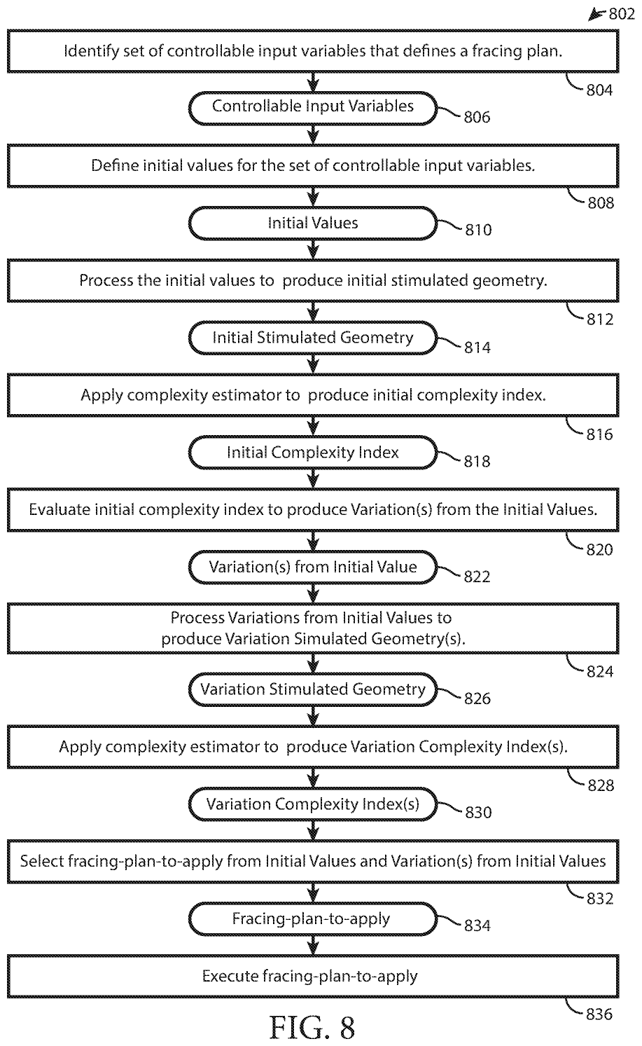

FIG. 8 is a flow chart depicting a process for selecting a fracing-plan-to-apply to optimize a complexity index. A process 802 for selecting a fracing-plan-to-apply to optimize a complexity index begins by identifying a set of controllable input variables that defines a fracing plan 804. The controllable input variable are selected such that a stimulated geometry is produced when the fracing plan is processed, a complexity index is produced when the stimulated geometry is processed by a complexity estimator, and the complexity index varies with each of the controllable input variables. The result is a set of controllable input variables 806.

The process 802 continues by defining initial values for the set of controllable input variables 808. The result is initial values for the set of controllable input variables 810.

The process 802 continues by processing the initial values of the set of controllable input variables 810, for example by the fracture simulator 506, to produce an initial stimulated geometry 812. Alternatively, the initial stimulated geometry could be derived by applying fracture mapping algorithms to microseismic measurements or to measurements from surface tiltmeters. The result is an initial stimulated geometry 814.

The process 802 continues by applying the complexity estimator to the initial stimulated geometry 814 to produce an initial complexity index 816. The result is an initial complexity index 818.

The process 802 continues by evaluating the initial complexity index 818 to identify at least one variation from the initial values 820. The evaluations may be made in a design of experiment manner, where a user investigates the input variable space for optimal values of these indices, or as an optimization run to maximize the complexity index via methods such as Newton Raphson method, Gradient descent method, etc. Such variations may be changes in one or more of the number and location of stages, the number and location of clusters within the stages, the number and location of perforations within the clusters, the volume of hydraulic fluid pumped, and the volume of proppant pumped. The result is/are variations from the initial values 822.

The process 802 continues by processing the at least one variation from the initial values 822, for example by applying the fracture simulator 506, to produce a variation stimulated geometry for each of the at least one variation from the initial values 824. Alternatively, the variation stimulated geometry for each of the at least one variation from the initial values 824 could be derived by applying a fracture mapping algorithm to microseismic measurements or to measurements from surface tiltmeters. The result is/are variation stimulated geometry for each of the at least one variation from the initial values 826.

The process 802 continues by applying the complexity estimator to the at least one variation stimulated geometry 826 to produce a variation complexity index for each of the at least one variation from the initial values 828. The result is/are variation complexity index for each of the at least one variation from the initial values 830.

The process 802 continues by selecting the fracing-plan-to-apply from among the initial values and the at least one variation from the initial values 832. The selection may be made by a user presented with the initial values 810, the initial complexity index 818, the variation(s) from initial values 822, and the variation complexity index(s) 830. Alternatively, a computer may make a recommendation using one of the optimizing techniques described above. The result is the fracing-plan-to-apply 834.

Optionally (not shown in FIG. 8), the process 802 may iterate by evaluating the available complexity indices, generating additional variations from initial values, and repeating the process.

The process continues by executing the fracing-plan-to-apply 836.

It will be understood that a computer is typically necessary to produce the stimulated geometry 812, 824, to perform the complexity estimator function (which may include creating boundary shapes) 816, 828, to perform the evaluation function 820, and other functions described above.

Further examples consistent with the present teachings are set out in the following numbered clauses:

Clause 1. A method for selecting a fracing-plan-to-apply to optimize a complexity index, comprising:
identifying a set of controllable input variables that defines a fracing plan,
   wherein a stimulated geometry is produced when the fracing plan is processed,
   wherein a complexity index is produced when the stimulated geometry is processed by a complexity estimator, and
   wherein the complexity index varies with each of the controllable input variables;
defining initial values for the set of controllable input variables;
processing the initial values of the set of controllable input variables to produce an initial stimulated geometry;
applying the complexity estimator to the initial stimulated geometry to produce an initial complexity index;
evaluating the initial complexity index to identify at least one variation from the initial values;
processing the at least one variation from the initial values to produce a variation stimulated geometry for each of the at least one variation from the initial values;
applying the complexity estimator to the at least one variation stimulated geometry to produce a variation complexity index for each of the at least one variation from the initial values;
selecting the fracing-plan-to-apply from among the initial values and the at least one variation from the initial values; and
executing the fracing-plan-to-apply.

Clause 2. The method of clause 1 wherein the complexity estimator:
fits a bounding shape to the stimulated geometry, and
determines a complexity index of the bounding shape.

Clause 3. The method of clause 2 wherein the bounding shape is defined by points selected from the group of points consisting of end points of fluid stimulation regions and end points of proppant-packed regions.

Clause 4. The method of any previous clause wherein the bounding shape is determined by applying a bounding shape generator selected from the group consisting of a convex hull polygon generator and an alpha shape polygon generator.

Clause 5. The method of any of clauses 1, 2, or 3 wherein the bounding shape is a predetermined shape.

Clause 6. The method of any previous clause wherein determining the complexity index of the bounding shape includes:
for a one-dimensional stimulated geometry having a length, comparing the length of the one-dimensional stimulated geometry to the circumference of the bounding shape,
for a two-dimensional stimulated geometry having an area, comparing the area of the two-dimensional stimulated geometry to the area of the bounding shape, and
for a three-dimensional stimulated geometry having a volume, comparing the volume of the three-dimensional stimulated geometry to the volume of the bounding shape.

Clause 7. The method of any previous clause wherein the complexity estimator includes:

fitting a bounding shape to the stimulated geometry, and

determining the compactness of the bounding shape.

Clause 8. The method of any previous clause wherein selecting a fracing-plan-to-apply from among the initial values and the at least one variation from the initial values includes:
displaying the initial stimulated geometry, the initial complexity index, the at least one variation stimulated geometries, and the respective revised complexity index for each of the at least one variations from the initial values, and
allowing a user to select from among the initial stimulated geometry and the at least on variation stimulated geometries.

Clause 9. The method of any previous clause wherein selecting a fracing-plan-to-apply from among the initial values and the at least one variation from the initial values includes applying an optimization to recommend an optimal geometry from among the initial stimulated geometry and the at least on variation stimulated geometries, wherein the optimization considers the initial stimulated geometry, the initial complexity index, the at least one variation stimulated geometries, and the respective revised complexity index for each of the at least one variations from the initial values.

Clause 10. The method of any previous clause wherein the optimization is selected from a group consisting of a Newton Raphson method and a Gradient descent method.

Clause 11. A computer program, stored in a non-transitory computer-readable tangible medium, on which is recorded a computer program, the computer program comprising executable instructions, that, when executed, perform a method for selecting a fracing-plan-to-apply to optimize a complexity index, the method comprising:
identifying a set of controllable input variables that defines a fracing plan,
   wherein a stimulated geometry is produced when the fracing plan is processed,
   wherein a complexity index is produced when the stimulated geometry is processed by a complexity estimator, and
   wherein the complexity index varies with each of the controllable input variables;
defining initial values for the set of controllable input variables;
processing the initial values of the set of controllable input variables to produce an initial stimulated geometry;
applying the complexity estimator to the initial stimulated geometry to produce an initial complexity index;
evaluating the initial complexity index to identify at least one variation from the initial values;
processing the at least one variation from the initial values to produce a variation stimulated geometry for each of the at least one variation from the initial values;
applying the complexity estimator to the at least one variation stimulated geometry to produce a variation complexity index for each of the at least one variation from the initial values;
selecting the fracing-plan-to-apply from among the initial values and the at least one variation from the initial values; and
executing the fracing-plan-to-apply.

Clause 12. The computer program of clause 11 wherein the complexity estimator:

fits a bounding shape to the stimulated geometry, and

determines a complexity index of the bounding shape.

Clause 13. The computer program of clause 12 wherein the bounding shape is defined by points selected from the group of points consisting of end points of fluid stimulation regions and end points of proppant-packed regions.

Clause 14. The computer program of any of clauses 11-13 wherein the bounding shape is determined by applying a bounding shape generator selected from the group consisting of a convex hull polygon generator and an alpha shape polygon generator.

Clause 15. The computer program of any of clauses 11-13 wherein the bounding shape is a predetermined shape.

Clause 16. The computer program of any of clauses 11-15 wherein determining the complexity index of the bounding shape includes:
for a one-dimensional stimulated geometry having a length, comparing the length of the one-dimensional stimulated geometry to the circumference of the bounding shape,
for a two-dimensional stimulated geometry having an area, comparing the area of the two-dimensional stimulated geometry to the area of the bounding shape, and
for a three-dimensional stimulated geometry having a volume, comparing the volume of the three-dimensional stimulated geometry to the volume of the bounding shape.

Clause 17. The computer program of any of clauses 11-16 wherein the complexity estimator includes:
fitting a bounding shape to the stimulated geometry, and
determining the compactness of the bounding shape.

Clause 18. The computer program of any of clauses 11-17 wherein selecting a fracing-plan-to-apply from among the initial values and the at least one variation from the initial values includes:
displaying the initial stimulated geometry, the initial complexity index, the at least one variation stimulated geometries, and the respective revised complexity index for each of the at least one variations from the initial values, and
allowing a user to select from among the initial stimulated geometry and the at least on variation stimulated geometries.

Clause 19. The computer program of any of clauses 11-18 wherein selecting a fracing-plan-to-apply from among the initial values and the at least one variation from the initial values includes applying an optimization to recommend an optimal geometry from among the initial stimulated geometry and the at least on variation stimulated geometries, wherein the optimization considers the initial stimulated geometry, the initial complexity index, the at least one variation stimulated geometries, and the respective revised complexity index for each of the at least one variations from the initial values.

Clause 20. The computer program of any of clauses 11-19 wherein the optimization is selected from a group consisting of a Newton Raphson method and a Gradient descent method.

The operations of the flow diagrams are described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for selecting a fracing-plan-to-apply to optimize a complexity index, comprising:
identifying a set of controllable input variables that defines a fracing plan,
wherein a stimulated geometry is produced when the fracing plan is processed,
wherein a complexity index is produced when the stimulated geometry is processed by a complexity estimator, and
wherein the complexity index varies with each of the controllable input variables;
defining initial values for the set of controllable input variables;
processing the initial values of the set of controllable input variables to produce an initial stimulated geometry;
applying the complexity estimator to the initial stimulated geometry to produce an initial complexity index;
evaluating the initial complexity index to identify at least one variation from the initial values;
processing the at least one variation from the initial values to produce a variation stimulated geometry for each of the at least one variation from the initial values;
applying the complexity estimator to the at least one variation stimulated geometry to produce a variation complexity index for each of the at least one variation from the initial values;
selecting the fracing-plan-to-apply from among the initial values and the at least one variation from the initial values; and
executing the fracing-plan-to-apply.

2. The method of claim 1 wherein the complexity estimator:
fits a bounding shape to the stimulated geometry, and
determines a complexity index of the bounding shape.

3. The method of claim 2 wherein the bounding shape is defined by points selected from the group of points consisting of end points of fluid stimulation regions and end points of proppant-packed regions.

4. The method of claim 2 wherein the bounding shape is determined by applying a bounding shape generator selected from the group consisting of a convex hull polygon generator and an alpha shape polygon generator.

5. The method of claim 2 wherein the bounding shape is a predetermined shape.

6. The method of claim 2 wherein determining the complexity index of the bounding shape includes:
for a one-dimensional stimulated geometry having a length, comparing the length of the one-dimensional stimulated geometry to the circumference of the bounding shape,
for a two-dimensional stimulated geometry having an area, comparing the area of the two-dimensional stimulated geometry to the area of the bounding shape, and
for a three-dimensional stimulated geometry having a volume, comparing the volume of the three-dimensional stimulated geometry to the volume of the bounding shape.

7. The method of claim 1 wherein the complexity estimator includes:
fitting a bounding shape to the stimulated geometry, and
determining the compactness of the bounding shape.

8. The method of claim 1 wherein selecting a fracing-plan-to-apply from among the initial values and the at least one variation from the initial values includes:
displaying the initial stimulated geometry, the initial complexity index, the at least one variation stimulated geometries, and the respective revised complexity index for each of the at least one variations from the initial values, and
allowing a user to select from among the initial stimulated geometry and the at least on variation stimulated geometries.

9. The method of claim 1 wherein selecting a fracing-plan-to-apply from among the initial values and the at least one variation from the initial values includes applying an optimization to recommend an optimal geometry from among the initial stimulated geometry and the at least on variation stimulated geometries, wherein the optimization considers the initial stimulated geometry, the initial complexity index, the at least one variation stimulated geometries, and the respective revised complexity index for each of the at least one variations from the initial values.

10. The method of claim 9 wherein the optimization is selected from a group consisting of a Newton Raphson method and a Gradient descent method.

11. A computer program, stored in a non-transitory computer-readable tangible medium, on which is recorded a computer program, the computer program comprising executable instructions, that, when executed, perform a method for selecting a fracing-plan-to-apply to optimize a complexity index, the method comprising:
identifying a set of controllable input variables that defines a fracing plan,
wherein a stimulated geometry is produced when the fracing plan is processed,
wherein a complexity index is produced when the stimulated geometry is processed by a complexity estimator, and
wherein the complexity index varies with each of the controllable input variables;
defining initial values for the set of controllable input variables;
processing the initial values of the set of controllable input variables to produce an initial stimulated geometry;
applying the complexity estimator to the initial stimulated geometry to produce an initial complexity index;
evaluating the initial complexity index to identify at least one variation from the initial values;
processing the at least one variation from the initial values to produce a variation stimulated geometry for each of the at least one variation from the initial values;
applying the complexity estimator to the at least one variation stimulated geometry to produce a variation complexity index for each of the at least one variation from the initial values;
selecting the fracing-plan-to-apply from among the initial values and the at least one variation from the initial values; and
executing the fracing-plan-to-apply.

12. The computer program of claim 11 wherein the complexity estimator:
fits a bounding shape to the stimulated geometry, and
determines a complexity index of the bounding shape.

13. The computer program of claim 12 wherein the bounding shape is defined by points selected from the group of points consisting of end points of fluid stimulation regions and end points of proppant-packed regions.

14. The computer program of claim 12 wherein the bounding shape is determined by applying a bounding shape generator selected from the group consisting of a convex hull polygon generator and an alpha shape polygon generator.

15. The computer program of claim 12 wherein the bounding shape is a predetermined shape.

16. The computer program of claim 12 wherein determining the complexity index of the bounding shape includes:
for a one-dimensional stimulated geometry having a length, comparing the length of the one-dimensional stimulated geometry to the circumference of the bounding shape,
for a two-dimensional stimulated geometry having an area, comparing the area of the two-dimensional stimulated geometry to the area of the bounding shape, and
for a three-dimensional stimulated geometry having a volume, comparing the volume of the three-dimensional stimulated geometry to the volume of the bounding shape.

17. The computer program of claim 11 wherein the complexity estimator includes:
fitting a bounding shape to the stimulated geometry, and
determining the compactness of the bounding shape.

18. The computer program of claim 11 wherein selecting a fracing-plan-to-apply from among the initial values and the at least one variation from the initial values includes:
displaying the initial stimulated geometry, the initial complexity index, the at least one variation stimulated geometries, and the respective revised complexity index for each of the at least one variations from the initial values, and
allowing a user to select from among the initial stimulated geometry and the at least on variation stimulated geometries.

19. The computer program of claim 11 wherein selecting a fracing-plan-to-apply from among the initial values and the at least one variation from the initial values includes applying an optimization to recommend an optimal geometry from among the initial stimulated geometry and the at least on variation stimulated geometries, wherein the optimization considers the initial stimulated geometry, the initial complexity index, the at least one variation stimulated geometries, and the respective revised complexity index for each of the at least one variations from the initial values.

20. The computer program of claim 19 wherein the optimization is selected from a group consisting of a Newton Raphson method and a Gradient descent method.
